(19) United States
(12) Patent Application Publication
(10) Pub. No.: US 2025/0162556 A1
(43) Pub. Date: May 22, 2025

(54) BRAKING CONTROL DEVICE FOR VEHICLE

(71) Applicant: ADVICS CO., LTD., Kariya-shi, Aichi-ken (JP)

(72) Inventors: Takuya NAKANO, Kariya-shi, Aichi-ken (JP); Shunya WATANABE, Kariya-shi, Aichi-ken (JP); Takashi EBINE, Kariya-shi, Aichi-ken (JP); Keisuke TANAKA, Kariya-shi, Aichi-ken (JP)

(73) Assignee: ADVICS CO., LTD., Kariya-shi, Aichi-ken (JP)

(21) Appl. No.: 18/840,381

(22) PCT Filed: Mar. 10, 2023
(86) PCT No.: PCT/JP2023/009432

§ 371 Date: Aug. 21, 2024

(30) Foreign Application Priority Data
Mar. 10, 2022 (JP) 2022-036959

(51) Int. Cl. B60T 13/20

(52) U.S. Cl. CPC B60T 13/20

(57) ABSTRACT

A braking control device for a vehicle includes an upper braking unit configured to pressurize a supply pressure by throttling, with a pressure adjustment valve, a circulation flow discharged by a fluid pump driven by an electric motor, and a lower braking unit disposed between the upper braking unit and a wheel cylinder and configured to pressurize the supply pressure to output a wheel pressure to the wheel cylinder. In a case where the lower braking unit pressurizes the wheel pressure, the upper braking unit reduces a rotation number of the electric motor as compared with a case where the lower braking unit does not pressurize the wheel pressure.

### TECHNICAL FIELD

The present disclosure relates to a braking control device for a vehicle.

### BACKGROUND ART

PTL 1 describes a liquid pressure control unit that realizes compatibility of control accuracy and response of a control of liquid pressures at wheel brakes by adopting a concept of a flow rate control. In PTL 1, a controller obtains target liquid amounts for the wheel brakes based on target liquid pressures, and obtains actual liquid amounts of the wheel brakes based on the liquid pressures detected by a braking liquid pressure detection unit. Then, target flow rates for the wheel brakes are obtained based on the target liquid amounts and the actual liquid amounts, and an operation of the liquid pressure control unit is controlled based on the target flow rates.

The applicant has developed a braking control device as described in PTL 2. The device in PTL 2 includes two components, that is, upper and lower fluid units. In the upper fluid unit, a braking liquid discharged by a fluid pump driven by an electric motor is adjusted to an adjustment liquid pressure (also referred to as a “servo pressure”). An input liquid pressure (also referred to as a “supply pressure”) adjusted by the servo pressure is transmitted as a wheel pressure to a wheel cylinder via the lower fluid unit. When the wheel pressure is increased by the lower fluid unit, a fluctuation in the liquid pressure may occur. A braking control device is required to deal with the fluctuation in the liquid pressure.

### CITATION LIST

### Patent Literature

PTL 1: JP2008-296704A
PTL 2: JP2019-059294A

### SUMMARY

### Technical Problem

An object of the present disclosure is to provide a braking control device for a vehicle which includes two braking units and can prevent a fluctuation in a liquid pressure when pressurization is performed by a lower braking unit.

### Solution to Problem

A braking control device (SC) for a vehicle according to the present disclosure includes an upper braking unit (SA) configured to pressurize a supply pressure (Pm) by throttling, with a pressure adjustment valve (UA), a circulation flow (KN) discharged by a fluid pump (QA) driven by an electric motor (MA), and a lower braking unit (SB) disposed between the upper braking unit (SA) and a wheel cylinder (CW) and configured to pressurize the supply pressure (Pm) to output a wheel pressure (Pw) to the wheel cylinder (CW). In a case where the lower braking unit (SB) pressurizes the wheel pressure (Pw), the upper braking unit (SA) reduces a rotation number (Na) of the electric motor (MA) as compared with a case where the lower braking unit (SB) does not pressurize the wheel pressure (Pw).

A braking control device (SC) for a vehicle according to the present disclosure includes an upper braking unit (SA) configured to, according to a required braking amount (Bs), pressurize a supply pressure (Pm) by throttling, with a pressure adjustment valve (UA), a circulation flow (KN) discharged by a fluid pump (QA) driven by an electric motor (MA), and a lower braking unit (SB) disposed between the upper braking unit (SA) and a wheel cylinder (CW) and configured to pressurize the supply pressure (Pm) to output a wheel pressure (Pw) to the wheel cylinder (CW). The upper braking unit (SA) calculates a target pressure (Pt) based on the required braking amount (Bs), and when the lower braking unit (SB) does not pressurize the wheel pressure (Pw), the upper braking unit (SA) controls a rotation number (Na) of the electric motor (MA) based on an instruction flow rate (Qs) calculated from the target pressure (Pt) and a compensation flow rate (Qh) calculated from the supply pressure (Pm). On the other hand, when the lower braking unit (SB) pressurizes the wheel pressure (Pw), the upper braking unit (SA) controls the rotation number (Na) of the electric motor (MA) based only on the compensation flow rate (Qh).

According to the above-described configuration, when the pressurization is performed by the lower braking unit SB, a change in a flow rate in the upper braking unit SA is prevented, and therefore a fluctuation in a liquid pressure in the upper braking unit SA is prevented.

### BRIEF DESCRIPTION OF DRAWINGS

FIG. 1 is a schematic diagram for illustrating an overall configuration of a vehicle JV equipped with a braking control device SC according to the present disclosure.

FIG. 2 is a schematic diagram for illustrating a configuration example of an upper braking unit SA.

FIG. 3 is a schematic diagram for illustrating a configuration example of a lower braking unit SB.

FIG. 4 is a block diagram for illustrating a control of a pressure adjustment valve UA.

FIG. 5 is a block diagram for illustrating a first control example of an upper electric motor MA.

FIGS. 6A and 6B are time series diagrams for illustrating a second control example of the upper electric motor MA.

### DESCRIPTION OF EMBODIMENTS

### <Symbols of Constituent Members or the Like and Subscripts at the End of Symbols>

In the following description, constituent members, calculation processing, signals, characteristics, and values denoted by the same symbols, such as “CW”, have the same function. Subscripts “f” and “r” added to the end of the symbols related to respective wheels are comprehensive symbols indicating which system of the front and rear wheels these subscripts relate to. For example, wheel cylinders CW provided in wheels are expressed as a “front wheel cylinder CWf” and a “rear wheel cylinder CWr”. Furthermore, the subscripts “f” and “r” at the end of the symbols can be omitted. When the subscripts “f” and “r” are omitted, each symbol represents a generic term. For example, “CW” is a generic term for wheel cylinders provided in front and rear wheels of a vehicle.

In a fluid passage from a master cylinder CM to the wheel cylinders CW, a side close to the master cylinder CM (a side far from the wheel cylinders CW) is referred to as an “upper portion”, and a side close to the wheel cylinders CW (a side far from the master cylinder CM) is referred to as a “lower portion”. In circulation flows KN, KL of a braking liquid BF, a side close to discharge portions of fluid pumps QA, QB (a side away from suction portions) is referred to as an “upstream side”, and a side close to the suction portions of the fluid pumps QA, QB (a side away from the discharge portions) is referred to as a “downstream side”.

An upper actuator YA (also referred to as an “upper fluid unit”) of an upper braking unit SA, a lower actuator YB (also referred to as a “lower fluid unit”) of a lower braking unit SB, and the wheel cylinders CW are connected by the fluid passage (a communication passage HS). Furthermore, in the upper and lower actuators YA, YB, various components (UA and the like) are connected by the fluid passage. Here, the “fluid passage” is a passage for moving the braking liquid BF, and includes piping, a flow passage in an actuator, a hose, and the like. In the following description, the communication passage HS, a reflux passage HK, a return passage HL, a reservoir passage HR, an input passage HN, servo a passage HV, a depressurization passage HG, and the like are fluid passages.

<Vehicle JV Equipped with Braking Control Device SC>

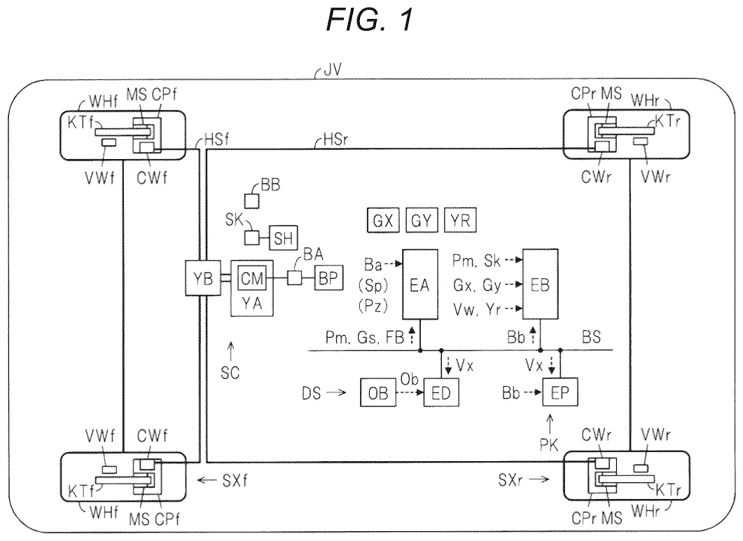

An overall configuration of a vehicle JV equipped with a braking control device SC according to the present disclosure will be described with reference to a schematic diagram of FIG. 1. The vehicle JV is provided with a driving assistance device DS in such a manner that a control (referred to as an “automatic braking control”) for automatically decelerating and stopping the vehicle is executed via the braking control device SC instead of a driver or by assisting the driver. The driving assistance device DS includes a distance sensor OB and a control unit ED (also referred to as a “driving assistance controller”) for the driving assistance device. A distance Ob (a relative distance) between an object (another vehicle, a fixed object, a person, a bicycle, a stop line, a sign, a signal, or the like) existing in front of the own vehicle JV and the own vehicle JV is detected by the distance sensor OB, and is input to the driving assistance controller ED. In the driving assistance controller ED, a required deceleration Gs for automatically stopping the vehicle JV is calculated based on the relative distance Ob. The required deceleration Gs is a target value of a vehicle deceleration for executing the automatic braking control. The required deceleration Gs is output to a communication bus BS.

The vehicle JV includes front wheel and rear wheel braking devices SXf, SXr (=SX). The braking device SX includes a brake caliper CP, a friction member MS (for example, a brake pad), and a rotating member KT (for example, a brake disc). The brake caliper CP is provided with the wheel cylinder CW. Due to a liquid pressure Pw (referred to as “wheel pressure”) in the wheel cylinder CW, the friction member MS is pressed against the rotating member KT fixed to each wheel WH. Accordingly, a friction braking force Fm is generated in the wheel WH. The “friction braking force Fm” is a braking force generated by the wheel pressure Pw.

The vehicle JV is provided with a parking brake device PK. The parking brake device PK includes a parking switch BB, a parking brake controller EP, and an electric actuator (not shown). The parking switch BB is a switch operated by the driver. A parking signal Bb is output from the parking switch BB and input to the parking brake controller EP (also referred to as a “parking controller”). When the vehicle JV is stopped (that is, when a vehicle body speed Vx is “0”), in the parking controller EP, the parking brake is applied when the parking signal Bb is in an ON state, and the parking brake is released when the parking signal Bb is in an OFF state. Here, the parking brake is activated and released by the electric actuator provided on the rear wheel. The vehicle body speed Vx is input to the parking controller EP so as to determine a stop state of the vehicle JV.

The parking signal Bb is also input to the braking control device SC (in particular, a lower controller EB). In a state where the vehicle JV is traveling (for example, a state where the vehicle body speed Vx is equal to or higher than a predetermined vehicle speed vx), if the parking signal Bb enters into the ON state, the electric actuator is not operated, and the wheel pressure Pw is increased to a predetermined pressure pw (a constant) set in advance by the braking control device SC. A control in which the wheel pressure Pw is increased based on the parking signal Bb while the vehicle is traveling is referred to as a “dynamic brake control”.

The vehicle JV includes a braking operation member BP and a steering operation member SH. The braking operation member BP (for example, a brake pedal) is a member operated by the driver to decelerate the vehicle JV. The steering operation member SH (for example, a steering wheel) is a member operated by the driver to turn the vehicle JV.

The vehicle JV includes various sensors (BA and the like) listed below. Detection signals (Ba and the like) of these sensors are input to the upper and lower braking units SA, SB (in particular, the controllers EA, EB) and used for various controls.
A braking operation amount sensor BA that detects an operation amount Ba (referred to as a braking operation amount) of the braking operation member BP is provided. For example, an operation displacement sensor SP that detects an operation displacement Sp of the braking operation member BP is provided as the braking operation amount sensor BA. In addition, a simulator pressure sensor PZ that detects a liquid pressure Pz (referred to as a “simulator pressure”) of a stroke simulator SS is employed. In the braking control device SC, the braking operation amount Ba is a generic term for signals indicating a braking intention of the driver, and the braking operation amount sensor BA is a generic term for sensors that detect the braking operation amount Ba. The braking operation amount Ba is input to an upper controller EA. In the upper braking unit SA, a control (referred to as a “service brake control”) related to the service brake is executed based on the braking operation amount Ba, and a supply pressure Pm (result, the wheel pressure Pw) is generated.
A wheel speed sensor VW that detects a rotation speed Vw (a wheel speed) of the wheel WH is provided. The wheel speed Vw is input to the lower controller EB. In the lower controller EB, the vehicle body speed Vx is calculated based on the wheel speed Vw. Furthermore, in the lower controller EB, based on the wheel speed Vw and the vehicle body speed Vx, an antilock brake control for preventing the wheel WH from being locked is executed.
A steering operation amount sensor SK that detects an operation amount Sk (a steering operation amount, for example, a steering angle) of the steering operation member SH is provided. The vehicle JV (in particular, a vehicle body) is provided with a yaw rate sensor YR that detects a yaw rate Yr, a longitudinal acceleration sensor GX that detects a longitudinal acceleration Gx, and a lateral acceleration sensor GY that detects a lateral acceleration Gy. These sensor signals are input to the lower controller EB. In the lower controller EB, oversteer and understeer are prevented, and an electronic stability control (ESC) for stabilizing a yawing behavior of the vehicle JV is executed.
A brake assist control (so-called BA control) is executed based on an operation speed dB, which is an amount of change over time of the braking operation amount Ba. When the driver operates the braking operation member BP rapidly (that is, when the operation speed dB is equal to or higher than a predetermined speed db set in advance), the brake assist control assists generation of the wheel pressure Pw being greater than the wheel pressure Pw corresponding to the operation amount Ba of the braking operation member BP. For example, an operation change amount ds, which is a time differential value of the operation displacement Sp, is adopted as the operation speed dB.

The vehicle JV includes the braking control device SC. In the braking control device SC, a front-rear type (also referred to as “II type”) is adopted for the braking system including two systems. The actual wheel pressure Pw is adjusted by the braking control device SC.

The braking control device SC includes the two braking units SA, SB. The upper braking unit SA includes the upper actuator YA (the upper fluid unit) and the upper controller EA (an upper control unit). The upper actuator YA is controlled by the upper controller EA. The lower braking unit SB is disposed between the upper braking unit SA and the wheel cylinder CW. The lower braking unit SB includes the lower actuator YB (the lower fluid unit) and the lower controller EB (a lower control unit). The lower actuator YB is controlled by the lower controller EB.

The upper braking unit SA (in particular, the upper controller EA), the lower braking unit SB (in particular, the lower controller EB), the driving assistance device DS (in particular, the driving assistance controller ED), and the parking brake device PK (in particular, the parking controller EP) are connected to the communication bus BS. The “communication bus BS” has a network structure in which a plurality of controllers (control units) are suspended from a communication line. Signal transmission is performed between a plurality of controllers (EA, EB, ED, EP, and the like) by the communication bus BS. That is, the plurality of controllers can transmit signals (detection values, calculation values, control flags, and the like) to the communication bus BS, and can receive the signals from the communication bus BS.

### <Upper Braking Unit SA>

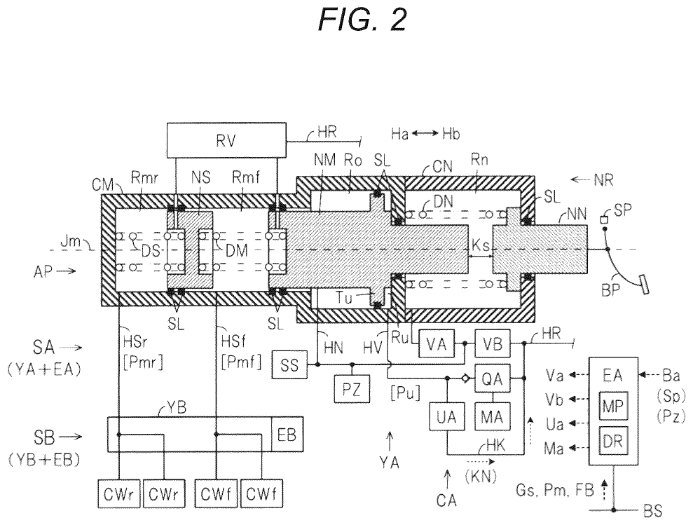

A configuration example of the upper braking unit SA will be described with reference to a schematic diagram of FIG. 2. The upper braking unit SA generates the supply pressure Pm according to an operation of the braking operation member BP (a brake pedal). The supply pressure Pm is finally supplied to the wheel cylinder CW via the communication passage HS (the fluid passage) and the lower braking unit SB. The upper braking unit SA includes the upper actuator YA and the upper controller EA.

### <<Upper Actuator YA>>

The upper actuator YA includes an applying unit AP, a pressure adjustment unit CA, and an input unit NR.

### [Applying Unit AP]

In response to the operation of the braking operation member BP, the supply pressure Pm is output from the applying unit AP. The applying unit AP includes the tandem type master cylinder CM and primary and secondary master pistons NM, NS.

The primary and secondary master pistons NM, NS are inserted into the tandem type master cylinder CM. The inside of the master cylinder CM is divided into four liquid pressure chambers Rmf, Rmr, Ru, and Ro by the two master pistons NM, NS. The front wheel and rear wheel master chambers Rmf, Rmr (=Rm) are divided by one side bottom of the master cylinder CM and the master pistons NM, NS. Furthermore, the inside of the master cylinder CM is partitioned into the servo chamber Ru and the reaction force chamber Ro by a flange portion Tu of the master piston NM. The master chamber Rm and the servo chamber Ru are arranged to face each other with the flange portion Tu sandwiched therebetween. The liquid pressure chambers Rmf, Rmr, Ru, and Ro are sealed by seal members SL. A pressure receiving area rm of the master chamber Rm and a pressure receiving area ru of the servo chamber Ru are made equal.

At the time of non-braking, the master pistons NM, NS are at a most retreating position (that is, a position at which a volume of the master chamber Rm becomes maximum). In this state, the master chamber Rm of the master cylinder CM communicates with a master reservoir RV. The braking liquid BF is stored in the master reservoir RV (also referred to as an atmospheric pressure reservoir). When the braking operation member BP is operated, the master pistons NM, NS are moved in a forward direction Ha (a direction in which the volume of the master chamber Rm decreases). The communication between the master chamber Rm and the master reservoir RV is blocked by the movement. When the master pistons NM, NS are further moved in the forward direction Ha, the front wheel and rear wheel supply pressures Pmf, Pmr (=Pm) are increased from “0 (an atmospheric pressure)”. Accordingly, the braking liquid BF pressurized to the supply pressure Pm is output (pumped) from the master chamber Rm of the master cylinder CM. The supply pressure Pm is a liquid pressure in the master chamber Rm, and thus the supply pressure Pm is also referred to as a “master pressure”.

### [Pressure Adjustment Unit CA]

A servo pressure Pu is supplied to the servo chamber Ru of the applying unit AP by the pressure adjustment unit CA. The pressure adjustment unit CA includes an upper electric motor MA, the upper fluid pump QA, and a pressure adjustment valve UA.

The upper electric motor MA (also simply referred to as an “electric motor”) drives the upper fluid pump QA (also simply referred to as the “fluid pump”). In the fluid pump QA, the suction portion and the discharge portion are connected by the reflux passage HK (fluid passage). The suction portion of the fluid pump QA is also connected to the master reservoir RV via the reservoir passage HR. A check valve is provided at the discharge portion of the fluid pump QA.

The reflux passage HK is provided with the normally open type pressure adjustment valve UA. The pressure adjustment valve UA is a linear type solenoid valve in which a valve opening amount is continuously controlled based on an energization state (for example, a supply current Ia). The pressure adjustment valve UA adjusts a liquid pressure difference (a differential pressure) between the upstream side and the downstream side, and thus the pressure adjustment valve UA is also referred to as a “differential pressure valve”.

When the electric motor MA is driven and the braking liquid BF is discharged from the fluid pump QA, the circulation flow KN (indicated by a dashed arrow) of the braking liquid BF is generated in the reflux passage HK. When the pressure adjustment valve UA is in a fully open state (at the time of non-energization as the pressure adjustment valve UA is of a normally open type), the liquid pressure Pu (referred to as the “servo pressure”) between the discharge portion of the fluid pump QA and the pressure adjustment valve UA in the reflux passage HK is “0 (the atmospheric pressure)”. When the energization amount Ia (the supply current) to the pressure adjustment valve UA is increased, the circulation flow KN (the flow of the braking liquid BF circulating in the reflux passage HK) is throttled by the pressure adjustment valve UA. In other words, the flow passage of the reflux passage HK is narrowed by the pressure adjustment valve UA, and an orifice effect due to the pressure adjustment valve UA is exhibited. Accordingly, the liquid pressure Pu on the upstream side of the pressure adjustment valve UA is increased from “0”. That is, in the circulation flow KN, the liquid pressure difference (the differential pressure) is generated between the liquid pressure Pu (the servo pressure) on the upstream side and the liquid pressure (the atmospheric pressure) on the downstream side with respect to the pressure adjustment valve UA. The differential pressure is adjusted by the supply current Ia to the pressure adjustment valve UA.

The reflux passage HK is connected to the servo chamber Ru via the servo passage HV (the fluid passage) at a portion between the discharge portion of the fluid pump QA (specifically, a downstream portion of the check valve) and the pressure adjustment valve UA. Therefore, the servo pressure Pu is introduced (supplied) to the servo chamber Ru. The increase in the servo pressure Pu presses the master pistons NM, NS in the forward direction Ha, and the liquid pressures Pmf, Pmr (the front wheel and rear wheel supply pressures) in the front wheel and rear wheel master chambers Rmf, Rmr are increased.

The front wheel and rear wheel master chambers Rmf, Rmr (=Rm) are connected to front wheel and rear wheel communication passages HSf and HSr (=HS). The front wheel and rear wheel communication passages HSf, HSr are connected to the front wheel and rear wheel cylinders CWf, CWr (=CW) via the lower braking unit SB (in particular, the lower actuator YB). Therefore, the front wheel and rear wheel supply pressures Pmf, Pmr are supplied from the upper braking unit SA to the front wheel and rear wheel cylinders CWf, CWr. Here, the front wheel supply pressure Pmf and the rear wheel supply pressure Pmr are equal (that is, “Pmf=Pmr”).

### [Input Unit NR]

The braking operation member BP is operated by the input unit NR so as to achieve a regenerative coordination control, but a state where the wheel pressure Pw is not generated is formed. The “regenerative coordination control” causes the friction braking force Fm (a braking force generated by the wheel pressure Pw) and a regenerative braking force Fg (a braking force generated by a motor/generator (not shown)) to work together such that kinetic energy of the vehicle JV can be efficiently recovered into electric energy by the motor/generator during the braking. The input unit NR includes an input cylinder CN, an input piston NN, an introduction valve VA, a release valve VB, the stroke simulator SS, and the simulator pressure sensor PZ.

The input cylinder CN is fixed to the master cylinder CM. The input piston NN is inserted into the input cylinder CN. The input piston NN is mechanically connected to the braking operation member BP via a clevis (U-shaped link) so as to be interlocked with the braking operation member BP (brake pedal). An end surface of the input piston NN and an end surface of the primary master piston NM have a gap Ks (also referred to as a “separation displacement”). By adjusting the gap Ks by the servo pressure Pu, the regenerative coordination control is achieved.

An input chamber Rn of the input unit NR is connected to the reaction force chamber Ro of the applying unit AP via the input passage HN (the fluid passage). The normally closed type introduction valve VA is provided in the input passage HN. The input passage HN is connected to the master reservoir RV via the reservoir passage HR between the introduction valve VA and the reaction force chamber Ro. The reservoir passage HR is provided with the normally open type release valve VB. The introduction valve VA and the release valve VB are on-off type solenoid valves. The stroke simulator Ss (also simply referred to as the “simulator”) is connected to the input passage HN between the introduction valve VA and the reaction force chamber Ro.

When the power supply to the introduction valve VA and the release valve VB is not performed, the introduction valve VA is closed and the release valve VB is opened. The input chamber Rn is sealed by closing the introduction valve VA, and the fluid is locked. Accordingly, the master pistons NM, NS are displaced integrally with the braking operation member BP. The simulator SS communicates with the master reservoir RV by opening the release valve VB. When power supply to the introduction valve VA and the release valve VB is performed, the introduction valve VA is opened, and the release valve VB is closed. Accordingly, the master pistons NM, NS can be separately displaced from the braking operation member BP. In this case, since the input chamber Rn is connected to the stroke simulator SS, an operation force Fp of the braking operation member BP is generated by the simulator SS. The simulator pressure sensor PZ is provided in the input passage HN between the introduction valve VA and the reaction force chamber Ro so as to detect the liquid pressure Pz (the simulator pressure) in the simulator SS. Note that since the simulator pressure Pz is also an internal pressure of the input chamber Rn, the simulator pressure Pz is also a state quantity representing the operation force Fp of the braking operation member BP.

A state where the master pistons NM, NS and the braking operation member BP are separately displaced from each other (at the time of energization of the solenoid valves VA and VB) is referred to as a “first mode (or a by-wire mode)”. In the first mode, the braking control device SC functions as a brake-by-wire type device (that is, a device capable of generating the friction braking force Fm independently with respect t to a braking operation of the driver). Therefore, in the first mode, the wheel pressure Pw is generated independently of the operation of the braking operation member BP. On the other hand, a state where the master pistons NM, NS and the braking operation member BP are integrally displaced (at the time of non-energization of the solenoid valves VA and VB) is referred to as a “second mode (or a manual mode)”. In the second mode, the wheel pressure Pw is linked to the braking operation of the driver. In the input unit NR, one operation mode of the first mode (the by-wire mode) and the second mode (the manual mode) is selected based on the presence or absence of the power supply to the introduction valve VA and the release valve VB.

### <<Upper Controller EA>>

The upper actuator YA is controlled by the upper controller EA. The upper controller EA includes a microprocessor MP and a drive circuit DR. The upper controller EA is connected to the communication bus BS such that signals (detection values, calculation values, control flags, and the like) can be shared with other controllers (EB, ED, EP, and the like).

The braking operation amount Ba is input to the upper controller EA. The braking operation amount Ba is a generic term for a state quantity representing the operation amount of the braking operation member BP. The detection signal Sp (the operation displacement) of the operation displacement sensor SP and the detection signal Pz (the simulator pressure) of the simulator pressure sensor PZ are directly input to the upper controller EA from the braking operation amount sensor BA as the braking operation amount Ba. The supply pressure Pm or the like is input to the upper controller EA via the communication bus BS. The “supply pressure Pm” is an output pressure of the upper actuator YA. The supply pressure Pm is detected by a supply pressure sensor PM provided in the lower actuator YB and transmitted from the lower controller EB. The required deceleration Gs is a required value for the automatic braking control, is calculated by the driving assistance controller ED, and is transmitted from the driving assistance controller ED.

An algorithm for the pressure adjustment control is programmed in the upper controller EA (in particular, the microprocessor MP). The “pressure adjustment control” is a control for adjusting the supply pressure Pm (finally, the wheel pressure Pw). The pressure adjustment control is executed based on the braking operation amount Ba (the operation displacement Sp, the simulator pressure Pz), the required deceleration Gs, the supply pressure Pm, and the like. Here, the braking operation amount Ba and the required deceleration Gs are generically referred to as a “required braking amount Bs”. The required braking amount Bs is an input signal for instructing (requiring) generation of the supply pressure Pm (result, the wheel pressure Pw to be generated by the braking control device SC).

Based on the algorithm of the pressure adjustment control, the electric motor MA and various solenoid valves (UA and the like) constituting the upper actuator YA are driven by the drive circuit DR. In the drive circuit DR, an H-bridge circuit is implemented by a switching element (for example, a MOS-FET) to drive the electric motor MA. The drive circuit DR includes a switching element to drive the various solenoid valves (UA and the like). In addition, the drive circuit DR includes a motor current sensor (not shown) that detects a supply current Im (referred to as a “motor current”) to the electric motor MA, and a pressure adjustment valve current sensor (not shown) that detects the supply current Ia (referred to as a “pressure adjustment valve current”) to the pressure adjustment valve UA. The electric motor MA is provided with a rotation angle sensor (not shown) that detects a rotation angle Ka (referred to as a “motor rotation angle”) of a rotary element (a rotor) of the electric motor MA. Then, a motor rotation number Na is calculated based on the motor rotation angle Ka.

In the upper controller EA, a target current It (a target value) corresponding to the pressure adjustment valve current Ia (an actual value) is calculated based on the required braking amount Bs (Ba, Gs, and the like) for a vehicle. In the control of the pressure adjustment valve UA, the pressure adjustment valve current Ia is controlled to be close to and coincide with the target current It. In the upper controller EA, a target rotation number Nt (a target value) corresponding to the motor rotation number Na (an actual value) is calculated based on the required braking amount Bs for a vehicle. In the control of the electric motor MA, the motor current Im is controlled such that the actual rotation number Na is close to and coincides with the target rotation number Nt. Specifically, if “Nt>Na”, the motor current Im is increased such that the actual rotation number Na increases, and if “Nt<Na”, the motor current Im is decreased such that the actual rotation number Na decreases. Based on these control algorithms, a drive signal Ma for controlling the electric motor MA and drive signals Ua, Va, Vb for controlling the various solenoid valves UA, VA, VB are calculated. Then, according to the drive signals (Ma and the like), switching elements of the drive circuit DR are driven, and the electric motor MA and the solenoid valves UA, VA, VB are controlled.

### <Lower Braking Unit SB>

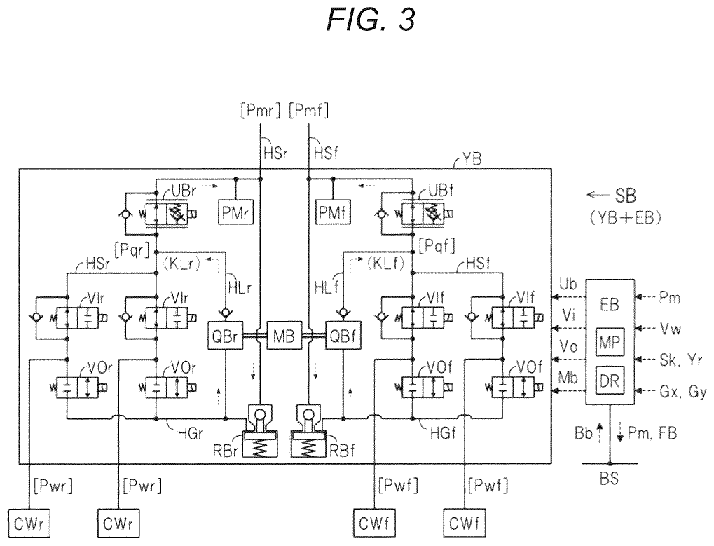

A configuration example of the lower braking unit SB of the braking control device SC will be described with reference to a schematic diagram of FIG. 3. The lower braking unit SB is a general-purpose unit (device) for executing at least one of the automatic braking control, the antilock brake control, the electronic stability control, the brake assist control, and the like. It is necessary to increase the wheel pressure Pw from the supply pressure Pm to execute these controls, and thus the lower braking unit SB is provided with a pressurizing function.

The front wheel and rear wheel supply pressures Pmf, Pmr (=Pm) are supplied from the upper braking unit SA to the lower braking unit SB. Then, in the lower braking unit SB, the front wheel and rear wheel supply pressures Pmf, Pmr are adjusted (increased or decreased), and are finally output as liquid pressures Pwf, Pwr (front wheel and rear wheel pressures) of the front wheel and rear wheel cylinders CWf, CWr. The lower braking unit SB includes the lower actuator YB and the lower controller EB.

### <<Lower Actuator YB>>

The lower actuator YB is provided between the upper actuator YA and the wheel cylinder CW in the communication passage HS. The lower actuator YB includes the supply pressure sensor PM, a control valve UB, the lower fluid pump QB, a lower electric motor MB, a pressure adjustment reservoir RB, an inlet valve VI, and an outlet valve VO.

Front wheel and rear wheel control valves UBf, UBr (=UB) are provided in the front wheel and rear wheel communication passages HSf, HSr (=HS). The control valve

UB is a normally open type linear solenoid valve (differential pressure valve) similar to the pressure adjustment valve UA. The wheel pressure Pw can be increased from the supply pressure Pm by the control valve UB individually for front wheel and rear wheel systems.

Front wheel and rear wheel supply pressure sensors PMf, PMr (=PM) are provided to detect the actual liquid pressures Pmf, Pmr (the front wheel and rear wheel supply pressures) supplied from the upper actuator YA (in particular, the front wheel and rear wheel master chambers Rmf, Rmr). The supply pressure sensor PM is also referred to as a “master pressure sensor”, and is built in the lower actuator YB. Signals of the front wheel and rear wheel supply pressures Pmf, Pmr (=Pm) are directly input to the lower controller EB and are output to the communication bus BS. Since the front wheel supply pressure Pmf and the rear wheel supply pressure Pmr are substantially the same, either one of the front wheel and rear wheel supply pressure sensors PMf, PMr may be omitted. For example, in a configuration in which the rear wheel supply pressure sensor PMr is omitted, only the front wheel supply pressure Pmf is detected by the front wheel supply pressure sensor PMf.

Front wheel and rear wheel return passages HLf, HLr (=HL) connect upper portions of the front wheel and rear wheel control valves UBf, UBr (portions of the communication passages HS closer to the upper actuator YA) to lower portions of the front wheel and rear wheel control valves UBf, UBr (portions of the communication passages HS closer to the wheel cylinders CW). The front wheel and rear wheel return passages HLf, HLr are provided with front wheel and rear wheel lower fluid pumps QBf, QBr (=QB) and front wheel and rear wheel pressure adjustment reservoirs RBf, RBr (=RB). The lower fluid pump QB is driven by the lower electric motor MB.

When the lower electric motor MB (also simply referred to as the “electric motor”) is driven, the braking liquid BF is suctioned from the upper portion of the control valve UB and is discharged to the lower portion of the control valve UB by the lower fluid pump QB (also simply referred to as the “fluid pump”). Accordingly, the circulation flow KL (that is, front wheel and rear wheel circulation flows KLf, KLr as indicated by dashed arrows) of the braking liquid BF, including the fluid pump QB, the control valve UB, and the pressure adjustment reservoir RB, is generated in the communication passage HS and the return passage HL. When the flow passage of the communication passage HS is narrowed by the control valve UB and the circulation flow KL of the braking liquid BF is throttled, the orifice effect in this case increases a liquid pressure Pq (referred to as an “adjustment pressure”) at the lower portion of the control valve UB from the liquid pressure Pm (the supply pressure) at the upper portion of the control valve UB. In other words, in the circulation flow KL, with respect to the control valve UB, the liquid pressure difference (differential pressure) between the liquid pressure Pm (the supply pressure) on the downstream side and the liquid pressure Pq (the adjustment pressure) on the upstream side is adjusted by the control valve UB. In terms of a magnitude relationship between the supply pressure Pm and the adjustment pressure Pq, the adjustment pressure Pq is equal to or higher than the supply pressure Pm (that is, “Pq≥Pm”).

As described above, a generation mechanism of the adjustment pressure Pq in the lower actuator YB is the same as a generation mechanism of the servo pressure Pu in the upper actuator YA.

Inside the lower actuator YB, the front wheel and rear wheel communication passages HSf, HSr are respectively branched into two and connected to the front wheel and rear wheel cylinders CWf, CWr. The normally open type inlet valve VI and the normally closed type outlet valve VO are provided for each wheel cylinder CW such that each wheel pressure Pw can be adjusted individually. Specifically, the inlet valve VI is provided in the branched communication passage HS (that is, on the side closer to the wheel cylinder CW with respect to the branching portion of the communication passage HS). The communication passage HS is connected to the pressure adjustment reservoir RB via the depressurization passage HG (the fluid passage) at the lower portion of the inlet valve VI (the portion of the communication passage HS closer to the wheel cylinder CW). The outlet valve VO is disposed in the depressurization passage HG. On-off type solenoid valves are adopted as the inlet valve VI and the outlet valve VO. The wheel pressure Pw can be decreased from the supply pressure Pm (or the adjustment pressure Pq) individually at each wheel by the inlet valve VI and the outlet valve VO.

### <<Lower Controller EB>>

The lower actuator YB is controlled by the lower controller EB. The lower controller EB, similar to the upper controller EA, includes the microprocessor MP and the drive circuit DR. The lower controller EB is connected to the communication bus BS, and thus the upper controller EA and the lower controller EB can share signals via the communication bus BS.

The wheel speed Vw, the steering operation amount Sk, the yaw rate Yr, the longitudinal acceleration Gx, and the lateral acceleration Gy are input to the lower controller EB (in particular, the microprocessor MP). The lower controller EB calculates the vehicle body speed Vx based on the wheel speed Vw. The vehicle body speed Vx is transmitted to the communication bus BS so as to be used by other devices (DS, PK, and the like).

The lower controller EB executes the antilock brake control, the electronic stability control, and the like. Specifically, the lower controller EB drives the lower electric motor MB and various solenoid valves (UB and the like) constituting the lower actuator YB to execute these controls. In the drive circuit DR of the lower controller EB, an H-bridge circuit is implemented by a switching element (for example, a MOS-FET) to drive the lower electric motor MB. The drive circuit DR includes a switching element to drive the various solenoid valves (UB and the like). Based on a control algorithm programmed in the microprocessor MP, a drive signal Ub of the control valve UB, a drive signal Vi of the inlet valve VI, a drive signal Vo of the outlet valve VO, and a drive signal Mb of the lower electric motor MB are calculated. Based on the drive signals (Ub and the like), the drive circuit DR controls the lower electric motor MB and the solenoid valves UB, VI, VO.

The lower controller EB controls the inlet valve VI and the outlet valve VO to decrease, increase, and maintain the wheel pressure CW Pw for each wheel cylinder individually. When the inlet valve VI and the outlet valve VO are not supplied with power and operations thereof are stopped, the inlet valve VI is opened and the outlet valve VO is closed. In this state, the wheel pressure Pw is equal to the adjustment pressure Pq. When an ABS control is executed, the wheel pressure Pw is independently adjusted for each wheel cylinder CW by driving the inlet valve VI and the outlet valve VO. In order to decrease the wheel pressure Pw, the inlet valve VI is closed and the outlet valve VO is opened. An inflow of the braking liquid BF into the wheel cylinder CW is prevented, and the braking liquid BF in the wheel cylinder CW flows out to the pressure adjustment reservoir RB, and thus the wheel pressure Pw is decreased. In order to increase the wheel pressure Pw, the inlet valve VI is opened and the outlet valve VO is closed. The braking liquid BF is prevented from flowing out to the pressure adjustment reservoir RB, and the adjustment pressure Pq from the pressure adjustment valve UB is supplied to the wheel cylinder CW, and thus the wheel pressure Pw is increased. Here, an upper limit of the increase in the wheel pressure Pw is the adjustment pressure Pq. In order to maintain the wheel pressure Pw, both the inlet valve VI and the outlet valve VO are closed. Since the wheel cylinder CW is fluidically sealed, the wheel pressure Pw is maintained constant.

An operation flag FB indicating “whether pressurization is being performed by the lower braking unit SB (that is, whether power is being supplied to the control valve UB)” is transmitted from the lower controller EB to the upper controller EA via the communication bus BS. The “operation flag FB” is a control flag, and “0” indicates “pressurization is not performed by the lower braking unit SB (that is, the power supply to the control valve UB is stopped and the control valve UB is in a fully open state)”, and “1” indicates “pressurization is being performed by the lower braking unit SB (that is, the power is being supplied to the control valve UB and the circulation flow KL is being throttled by the control valve UB)”.

### <Drive Control of Pressure Adjustment Valve UA>

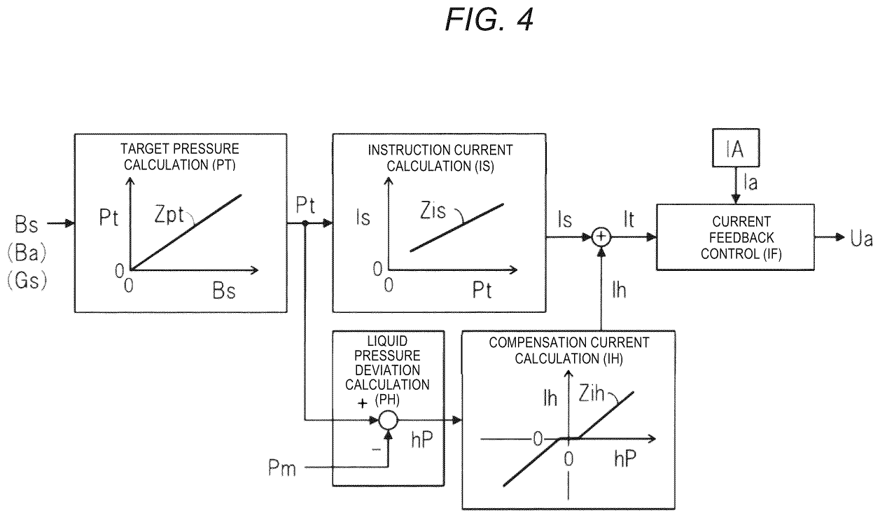

A control example of the pressure adjustment valve UA will be described with reference to the block diagram of FIG. 4. The processing is executed by the upper controller EA. The pressure adjustment valve UA adjusts the servo pressure Pu, and finally adjusts the supply pressure Pm (=Pw). The drive control of the pressure adjustment valve UA is implemented by a target pressure calculation block PT, an instruction current calculation block IS, a liquid pressure deviation calculation block PH, a compensation current calculation block IH, and a current feedback control block IF.

In the target pressure calculation block PT, a target pressure Pt is calculated based on the required braking amount Bs. The “required braking amount Bs” is a generic term for the required amount for the upper braking unit SA, and is an input for instructing the generation of the supply pressure Pm (that is, the wheel pressure Pw to be generated by the braking control device SC). The supply pressure Pm is requested based on at least one of the braking operation amount Ba and the required deceleration Gs. In this case, the required braking amount Bs is calculated based on the braking operation amount Ba and the required deceleration Gs. Specifically, the braking operation amount Ba and the required deceleration Gs are compared in the dimension of the vehicle deceleration, and the greater one is determined as the required braking amount Bs. The target pressure Pt is calculated based on the required braking amount Bs. The “target pressure Pt” is a target value corresponding to the supply pressure Pm. The target pressure Pt is calculated according to a calculation map Zpt set in advance such that the target pressure Pt increases as the required braking amount Bs increases.

In the instruction current calculation block IS, an instruction current Is is calculated based on the target pressure Pt and a calculation map Zis set in advance. The “instruction current Is” is a target value corresponding to the supply current Ia of the pressure adjustment valve UA required to achieve the target pressure Pt. According to the calculation map Zis, the instruction current Is is determined to increase as the target pressure Pt increases. The instruction current calculation block IS corresponds to a feedforward control based on the target pressure Pt.

In the liquid pressure deviation calculation block PH, a deviation hP (referred to as a “liquid pressure deviation”) between the target pressure Pt and the supply pressure Pm is calculated. Specifically, the supply pressure Pm is subtracted from the target pressure Pt to determine the liquid pressure deviation hP (that is, “hP=Pt−Pm”).

In the compensation current calculation block IH, a compensation current Ih is calculated based on the liquid pressure deviation hP and a calculation map Zih set in advance. The instruction current Is is calculated corresponding to the target pressure Pt, but an error may occur between the target pressure Pt and the supply pressure Pm. The “compensation current Ih” is used to compensate (decrease) this error. The compensation current Ih is determined to increase as the liquid pressure deviation hP increases according to the calculation map Zih.

Specifically, if the target pressure Pt is greater than the supply pressure Pm and the liquid pressure deviation hP has a positive sign, the compensation current Ih with a positive sign is determined such that the instruction current Is is increased. On the other hand, if the target pressure Pt is less than the supply pressure Pm and the liquid pressure deviation hP has a negative sign, the compensation current Ih with the negative sign is determined such that the instruction current Is is decreased. Here, a dead zone is provided in the calculation map Zih. The compensation current calculation block IH corresponds to a feedback control based on the supply pressure Pm.

The compensation current Ih is added to the instruction current Is to calculate the target current It (that is, “It=Is+Ih”). The “target current It” is a final target value of the current supplied to the pressure adjustment valve UA. That is, the target current It is determined as the sum of the instruction current Is, which is a feedforward term, and the compensation current Ih, which is a feedback term. Therefore, the drive control of the pressure adjustment valve UA includes the feedforward control (processing of the instruction current calculation block IS) and the feedback control (processing of the compensation current calculation block IH) in terms of the liquid pressure.

In the current feedback control block IF, the drive signal Ua is calculated based on the target current It (the target value) and the supply current Ia (the actual value) such that the supply current Ia is close to and coincides with the target current It. Here, the supply current Ia is detected by the pressure adjustment valve current sensor IA provided in the drive circuit DR. In the current feedback control block IF, if “It>Ia”, the drive signal Ua is determined such that the supply current Ia increases. On the other hand, if “It<Ia”, the drive signal Ua is determined such that the supply current Ia decreases. That is, in the current feedback control block IF, the feedback control related to the current is executed. Therefore, the drive control of the pressure adjustment valve UA includes the feedback control related to the current in addition to the feedback control related to the liquid pressure.

### <First Control Example of Electric Motor MA>

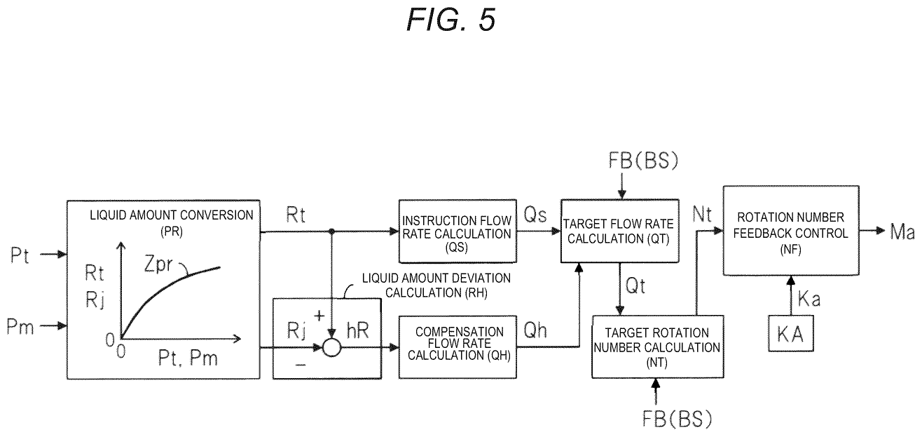

A first control example of the upper electric motor MA will be described with reference to the block diagram of FIG. 5. In the first control example, the electric motor MA is controlled based on a flow rate control. The drive control of the electric motor MA is executed by the upper controller EA. The control of the electric motor MA is implemented by a liquid amount conversion block PR, a liquid amount deviation calculation block RH, an instruction flow rate calculation block QS, a compensation flow rate calculation block QH, a target flow rate calculation block QT, a target rotation number calculation block NT, and a rotation number feedback control block NF.

In the liquid amount conversion block PR, a target liquid amount Rt and an actual liquid amount Rj are calculated based on the target pressure Pt and the supply pressure Pm. In the liquid amount conversion block PR, the target pressure Pt is converted to the target liquid amount Rt, and the supply pressure Pm is converted to the actual liquid amount Rj based on a calculation map Zpr set in advance. Here, the “target liquid amount Rt” is a liquid amount required to achieve the target pressure Pt (a volume of the braking liquid BF to be moved to the wheel cylinder CW). The “actual liquid amount Rj” is a liquid amount that has already flowed into the wheel cylinder CW to generate the supply pressure Pm (result, the wheel pressure Pw).

In the liquid amount deviation calculation block RH, a deviation hR (referred to as a “liquid amount deviation”) between the target liquid amount Rt and the actual liquid amount Rj is calculated. Specifically, the actual liquid amount Rj is subtracted from the target liquid amount Rt to determine the liquid amount deviation hR (that is, “hR=Rt−Rj”). The “liquid amount deviation hR” is a target value of the liquid amount (a volume) to flow into the wheel cylinder CW in the future to achieve the target pressure Pt.

In the instruction flow rate calculation block QS, an instruction flow rate Qs is calculated based on the target liquid amount Rt. Specifically, the target liquid amount Rt is time-differentiated to determine the instruction flow rate Qs (that is, “Qs=d(Rt)/dt”). The instruction flow rate Qs is a flow rate required to achieve the target pressure Pt, and corresponds to the feedforward term in the flow rate control. Therefore, the instruction flow rate calculation block QS corresponds to the feedforward control in the flow rate control.

In the compensation flow rate calculation block QH, a compensation flow rate Qh is calculated based on the liquid amount deviation hR. Specifically, the liquid amount deviation hR is time-differentiated to determine the compensation flow rate Qh (that is, “Qh=d(hR)/dt”). The compensation flow rate Qh is a flow rate required for the supply pressure Pm to coincide with the target pressure Pt, and corresponds to the feedback term in the flow rate control. Therefore, the compensation flow rate calculation block QH corresponds to the feedback control in the flow rate control.

In the target flow rate calculation block QT, a target flow rate Qt is calculated based on the instruction flow rate Qs and the compensation flow rate Qh. The “target flow rate Qt” is a final target value for achieving the target pressure Pt. Specifically, the instruction flow rate Qs and the compensation flow rate Qh are added together to determine the target flow rate Qt (that is, “Qt=Qs+Qh”).

In the target rotation number calculation block NT, the target rotation number Nt is calculated based on the target flow rate Qt. The “target rotation number Nt” is a target value corresponding to the rotation number Na (the actual value) of the electric motor MA. Specifically, the target rotation number Nt is determined based on a discharge amount (a volume of the braking liquid BF discharged per rotation) of the fluid pump QA so that the target rotation number Nt is greater as the target flow rate Qt increases. Furthermore, in the target rotation number Nt, a minimum flow rate of the pressure adjustment valve UA and a minimum rotation number of the electric motor MA are taken into consideration. The “minimum flow rate” is a lowest limit flow rate required for the pressure adjustment valve UA to adjust the servo pressure Pu, and is set in advance. The “minimum rotation number” is a minimum value of the rotation number at which the electric motor MA can continue to rotate stably. Taking these matters into consideration, a lower limit rotation number nt (a predetermined value set in advance) is set for the target rotation number Nt.

Therefore, if the target rotation number Nt calculated based on the target flow rate Qt is equal to or higher than the lower limit rotation number nt, no restriction is made by the lower limit rotation number nt, and the calculated target rotation number Nt is used as it is. On the other hand, if the target rotation number Nt calculated based on the target flow rate Qt is less than the lower limit rotation number nt, the target rotation number Nt is determined to be the lower limit rotation number nt (that is, “Nt=nt”).

In the rotation number feedback control block NF, the drive signal Ma is calculated based on the target rotation number Nt (the target value) and the motor rotation number Na (the actual value) so that the motor rotation number Na is close to and coincides with the target rotation number Nt. Here, the motor rotation number Na is calculated based on the detection value Ka (the rotation angle) of a rotation angle sensor KA provided on the electric motor MA. Specifically, the motor rotation angle Ka is time-differentiated to determine the motor rotation number Na. In the rotation number feedback control block NF, if “Nt>Na”, the drive signal Ma is determined such that the actual rotation number Na increases. On the other hand, if “Nt<Na”, the drive signal Ma is determined such that the actual rotation number Na decreases. That is, in the rotation number feedback control block NF, a feedback control related to the motor rotation number is executed.

### <Pressurization Source in Braking Control Device SC>

The braking control device SC includes two pressurization sources (power sources for increasing the wheel pressure Pw), the upper braking unit SA and the lower braking unit SB. When the wheel pressure Pw is pressurized by the upper braking unit SA, the upper electric motor MA is driven to discharge the braking liquid BF from the upper fluid pump QA, and the circulation flow KN (also referred to as an “upper circulation flow”) of the braking liquid BF is generated in the reflux passage HK. Based on the target pressure Pt calculated from the required braking amount Bs, the target current It (the pressure adjustment valve target current) for the pressure adjustment valve UA is calculated, and the actual supply current Ia (the pressure adjustment valve current) flowing through the pressure adjustment valve UA is controlled to be close to and coincide with the target current It. Here, the supply current Ia is detected by the pressure adjustment valve current sensor IA provided in the drive circuit DR of the upper controller EA. By supplying power to the pressure adjustment valve UA, the upper circulation flow KN is throttled, and the supply pressure Pm is pressurized, and as a result, the wheel pressure Pw is pressurized.

Similarly, when the wheel pressure Pw is pressurized by the lower braking unit SB, the lower electric motor MB is driven to discharge the braking liquid BF from the lower fluid pump QB, and the circulation flow KL (also referred to as a “lower circulation flow”) of the braking liquid BF is generated in the communication passage HS and the return passage HL. A target differential pressure St is calculated based on the required braking amount Bs. The “target differential pressure St” is a target value corresponding to the liquid pressure difference (the actual value) between the supply pressure Pm and the adjustment pressure Pq. Based on the target differential pressure St, a target current Iu (a control valve target current) for the control valve UB is calculated, and an actual supply current Ib (a control valve current) flowing through the control valve UB is controlled to be close to and coincide with the target current Iu. Here, the supply current Ib is detected by a control valve current sensor (not shown) provided in the drive circuit DR of the lower controller EB. By supplying power to the control valve UB, the lower circulation flow KL is throttled, and the wheel pressure Pw (=Pq) is increased from the supply pressure Pm.

In the braking control device SC, various controls are executed. The upper and lower braking units SA, SB are used as the pressurization sources for the various controls. The following summarizes the controls that require the pressurization and the pressurization sources thereof in the braking control device SC.
The service brake control (that is, a function related to the service brake) is executed by the pressurization performed by the upper braking unit SA. In the service brake control, the braking operation amount Ba is adopted as the required braking amount Bs. Based on the target pressure Pt calculated from the required braking amount Bs (=Ba), the supply pressure Pm is increased to coincide with the target pressure Pt. Here, the target pressure Pt is determined to be greater as the braking operation amount Ba increases. In the service brake control, since the lower braking unit SB does not perform the pressurization, the supply pressure Pm is output to the wheel cylinder CW as the wheel pressure Pw.
The dynamic brake control is executed by pressurization performed by the lower braking unit SB, taking into account redundancy of the braking control device SC. In the dynamic brake control, while the vehicle is traveling (that is, if the vehicle body speed Vx is greater than “0”), the required braking amount Bs is calculated based on the signal Bb (the parking signal) from the parking switch BB being switched from the OFF state to the ON state. The wheel pressure Pw is pressurized to the predetermined pressure pw according to the required braking amount Bs of the dynamic brake control. Here, the predetermined pressure pw is a predetermined value (a constant) set in advance.
The brake assist control is executed by the pressurization performed by either the upper braking unit SA or the lower braking unit SB. In the brake assist control, the required braking amount Bs is calculated based on the operation speed dB (an amount of change over time of the braking operation amount Ba, for example, an amount of change over time of the operation displacement Sp). The target pressure Pt calculated in the service brake control is increased based on the required braking amount Bs of the brake assist control. That is, in the brake assist control, the wheel pressure Pw is pressurized to be increased as compared with the case of the service brake control.
The automatic braking control is executed by the pressurization performed by either the upper braking unit SA or the lower braking unit SB. In the automatic braking control, the required braking amount Bs is calculated based on the required deceleration Gs. The wheel pressure Pw is pressurized based on the target pressure Pt calculated from the required braking amount Bs. Here, the target pressure Pt is determined to be greater as the required deceleration Gs increases.
The electronic stability control (in particular, a source pressure of the control) is executed by the pressurization performed by either the upper braking unit SA or the lower braking unit SB. In the electronic stability control, the required braking amount Bs is calculated based on the yaw rate Yr. Specifically, the required braking amount Bs is determined based on the deviation between a target behavior calculated from the steering operation amount Sk and an actual behavior calculated from the yaw rate Yr. The wheel pressure Pw is pressurized according to the required braking amount Bs of the electronic stability control so as to prevent the oversteer and the understeer and to stabilize a vehicle behavior. Note that the wheel pressure Pw in the electronic stability control is individually adjusted by the lower braking unit SB (in particular, the inlet valve VI and the outlet valve VO).

As described above, in the service brake control, the upper braking unit SA performs the pressurization, and in the dynamic brake control, the lower braking unit SB performs the pressurization. In the brake assist control, the automatic braking control, and the electronic stability control, the upper braking unit SA or the lower braking unit SB performs the pressurization. As an example, in the braking control device SC, the service brake control, the automatic braking control, and the electronic stability control are executed using the upper braking unit SA as the pressurization source, and the brake assist control and the dynamic brake control are executed using the lower braking unit SB as the pressurization source.

### <Fluctuation in Liquid Pressure During Pressurization Transition>

In the braking control device SC, while the pressurization is being performed by one of the upper and lower braking units SA, SB, the pressurization may be started by the other of the upper and lower braking units SA, SB. The pressurization performed by only one of the upper and lower braking units SA, SB is referred to as “single pressurization”, and pressurization by both the upper and lower braking units SA, SB is referred to as “joint pressurization”. That is, the above situation is a state where the single pressurization performed by the upper braking unit SA or the lower braking unit SB is transitioned to the joint pressurization performed by the upper and lower braking units SA, SB. Such a state transition is referred to as a “pressurization transition”. When the pressurization transition is performed, a liquid pressure change may occur in the servo pressure Pu (result, the supply pressure Pm and the wheel pressure Pw).

A reason for the fluctuation in the liquid pressure during the pressurization transition will be described. In the pressurization performed by the upper braking unit SA, the braking liquid BF is moved from the upper braking unit SA to the wheel cylinder CW via the lower braking unit SB, thereby increasing the wheel pressure Pw. The flow rate passing through the pressure adjustment valve UA changes due to the pressurization performed by the lower braking unit SB, and therefore the servo pressure Pu changes. Specifically, in the pressurization performed by the lower braking unit SB, the wheel pressure Pw is increased from the supply pressure Pm, and thus the wheel pressure Pw is higher than the supply pressure Pm. That is, when the lower braking unit SB does not perform the pressurization (also referred to as a “non-pressurization state of the lower braking unit SB”), the braking liquid BF is moved from the upper braking unit SA to the wheel cylinder CW, but when the lower braking unit SB performs the pressurization (also referred to as a “pressurization state of the lower braking unit SB”), the braking liquid BF is not moved from the upper braking unit SA to the wheel cylinder CW. In the above two cases (non-pressurization/pressurization state of the lower braking unit SB), if the electric motor MA is driven at the same rotation number, a flow rate of the upper circulation flow KN is greater in the pressurization state of the lower braking unit SB than in the non-pressurization state of the lower braking unit SB. Therefore, when the lower braking unit SB transitions from the non-pressurization state to the pressurization state, the servo pressure Pu (result, the supply pressure Pm and the wheel pressure Pw) increases with the increase in the flow rate of the upper circulation flow KN. The servo pressure Pu finally converges due to the control (that is, the liquid pressure feedback control) of the pressure adjustment valve UA based on the supply pressure Pm. However, in a transient state, the increase in the servo pressure Pu and the liquid pressure feedback control for preventing this increase cause the liquid pressures (Pu, Pm, Pq, Pw, and the like) to oscillate.

### <Prevention of Fluctuation in Liquid Pressure>

The control of the upper electric motor MA for preventing a fluctuation in the liquid pressure during the pressurization transition (that is, during the state transition from the single pressurization to the joint pressurization) will be described with reference to the block diagram of FIG. 5 again. The upper controller EA receives the operation flag FB transmitted from the lower controller EB through the communication bus BS. The operation flag FB is a control flag indicating whether the pressurization is performed by the lower braking unit SB. Specifically, “FB=0” indicates the “non-pressurization state of the lower braking unit SB (that is, power is not supplied to the control valve UB)”, and “FB=1” indicates the “pressurization state of the lower braking unit SB (that is, power is being supplied to the control valve UB)”.

The operation flag FB is input to the target rotation number calculation block NT. If “FB=0” and the lower braking unit SB does not perform the pressurization, the target rotation number Nt is calculated based on the above-described method. That is, the target rotation number Nt is determined to be greater as the target flow rate Qt increases. On the other hand, if “FB=1” and the lower braking unit SB performs the pressurization, the target rotation number Nt is calculated to be smaller than that when the lower braking unit SB does not perform the pressurization. For example, the target rotation number Nt is determined to be a predetermined rotation number nx. Here, the “predetermined rotation number nx” is a predetermined value (a constant) set in advance. For example, the predetermined rotation number nx can be determined to be equal to the lower limit rotation number nt. Here, the lower limit rotation number nt is a lowest limit rotation number required for the pressure adjustment valve UA to be able to adjust the servo pressure Pu and for the electric motor MA to rotate stably, and is set in advance as a constant.

In the target rotation number calculation block NT, the target rotation number Nt is calculated such that the target rotation number Nt is smaller when the lower braking unit SB performs the pressurization than that when the lower braking unit SB does not perform the pressurization. As a result, the rotation number Na of the electric motor MA is smaller when the lower braking unit SB performs the pressurization than that when the lower braking unit SB does not perform the pressurization. Accordingly, a change (in particular, the increase) in the flow rate in the upper braking unit SA during the state transition from the single pressurization to the joint pressurization is prevented. As a result, a sudden increase in the servo pressure Pu is avoided, and thus the fluctuation in the liquid pressure is prevented.

The operation flag FB may be input to the target flow rate calculation block QT, and the target flow rate Qt may be adjusted based on the presence or absence of pressurization performed by the lower braking unit SB. Specifically, if “FB=0” and the lower braking unit SB does not perform the pressurization, the target flow rate Qt is calculated by the above-described method. Specifically, the target flow rate Qt is calculated by adding up the instruction flow rate Qs calculated from the target pressure Pt and the compensation flow rate Qh calculated from the supply pressure Pm. The target flow rate Qt is converted into a target rotation number Nt based on a discharge rate of the fluid pump QA. That is, when the wheel pressure Pw is not pressurized by the lower braking unit SB, the rotation number Na of the electric motor MA is controlled based on the instruction flow rate Qs and the compensation flow rate Qh. On the other hand, if “FB=1” and the lower braking unit SB performs the pressurization, the instruction flow rate Qs is calculated to be “0”. That is, when the wheel pressure Pw is pressurized by the lower braking unit SB, the target flow rate Qt is calculated based only on the compensation flow rate Qh, and thus the rotation number Na of the electric motor MA is controlled based only on the compensation flow rate Qh.

At the beginning of braking (that is, a stage where the wheel pressure Pw starts to be generated), a liquid amount of the braking liquid BF consumed by the braking device SX (CP, MS, and the like) (referred to as an “amount of liquid consumed”) is large. In the rotation number control of the electric motor MA based on the flow rate, an amount of change over time of the required braking amount Bs is large at the beginning of braking, and thus the instruction flow rate Qs is calculated to be large. When the upper braking unit SA performs the single pressurization, the motor rotation number Na is rapidly increased by a component of the instruction flow rate Qs in the target flow rate Qt. Accordingly, since a large amount of braking liquid BF is moved to the wheel cylinder CW, a pressure increase response of the wheel pressure Pw at the beginning of braking is improved. On the other hand, when the lower braking unit SB performs the pressurization, a certain amount of the braking liquid BF has been already moved to the wheel cylinder CW by the lower braking unit SB, and thus there is no need to supply a large amount of braking liquid BF to the wheel cylinder CW. Therefore, even at the start of pressurization of the upper braking unit SA (that is, a time point of the pressurization transition), “Qs=0” is determined, and the target flow rate Qt is calculated to be small. As a result, the target rotation number Nt is decreased and the motor rotation number Na is decreased. Accordingly, the increase in the flow rate in the upper braking unit SA is prevented during the pressurization transition. Since a sudden increase in the servo pressure Pu is avoided, a fluctuation in the liquid pressure (that is, the supply pressure Pm and the wheel pressure Pw) is prevented.

Even if the upper braking unit SA starts the pressurization first and then the lower braking unit SB performs the pressurization, the instruction flow rate Qs is set to “0” at the time point when the lower braking unit SB starts the pressurization (that is, the time point of the pressurization transition), and the target flow rate Qt is determined. Similarly, the increase in the flow rate in the upper braking unit SA is prevented. Accordingly, a sudden increase in the servo pressure Pu is avoided, and the fluctuation in the liquid pressure is prevented.

### <Second Control Example of Electric Motor MA>

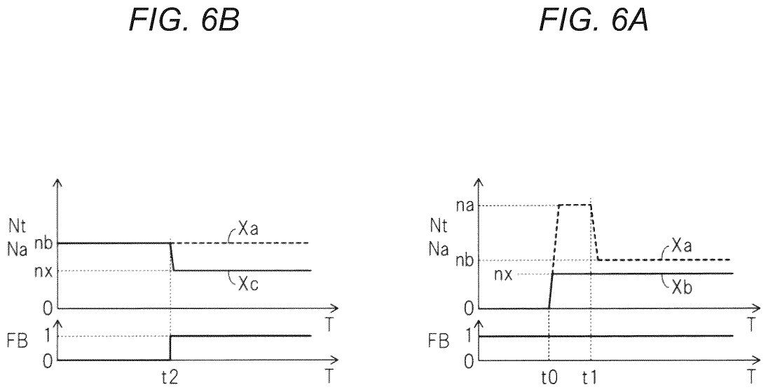

A second control example of the upper electric motor MA will be described with reference to time series diagrams of FIGS. 6A and 6B (diagrams showing a transition of state quantities with passage of a time T). In the first control example of the control of the electric motor MA, the target rotation number Nt is determined based on the flow rate (that is, the instruction flow rate Qs and the compensation flow rate Qh) required for pressurizing the wheel pressure Pw. Alternatively, in the second control example, the target rotation number Nt is determined in a pattern set in advance. Note that the actual rotation number Na is controlled to coincide with the target rotation number Nt, and thus, in the drawing, the target rotation number Nt and the actual rotation number Na overlap.

With reference to FIG. 6A, a case where the upper braking unit SA performs the pressurization when the lower braking unit SB does not perform the pressurization (that is, when the upper braking unit SA performs the single pressurization) will be described. In this case, as the time T passes, the target rotation number Nt is calculated as shown by a characteristic Xa (shown by a dashed line). When the upper braking unit SA starts the single pressurization at a time point to, the target rotation number Nt is rapidly increased to a starting rotation number na. The “starting rotation number na” is a predetermined value (a constant) set in advance. At the start of braking, the amount of liquid consumed by the braking device SX (the amount of fluid consumed due to rigidity of the brake caliper CP, the friction member MS, and the like) is large, and thus the target rotation number Nt is determined to be a relatively large value so that a large amount of braking liquid BF is supplied.

At a time point t1, the target rotation number Nt is decreased toward a steady rotation number nb. The “steady rotation number nb” is a predetermined value (a constant) that is set in advance and is smaller than the starting rotation number na. When a predetermined time tx (a constant set in advance) has elapsed since the start of the electric motor MA (that is, the time point to), the target rotation number Nt is decreased so that the motor rotation number Na is decreased. This is based on a matter that when the wheel pressure Pw is increased to a certain extent, the amount of liquid consumed by the braking device SX becomes smaller, and thus the amount of braking liquid BF is not so much required.

Next, a case where the upper braking unit SA performs the pressurization when the lower braking unit SB performs the pressurization (that is, the case of joint pressurization) will be described. When the pressurization transition is performed, the target rotation number Nt is calculated as shown by a characteristic Xb (shown by a solid line). At the time point to, the upper braking unit SA starts the pressurization. That is, before the time point to, the lower braking unit SB is in a single pressurization state, but at the time point to, the upper and lower braking units SA, SB are in the joint pressurization state. At the time point to when the pressurization transition is started, the target rotation number Nt is increased to the predetermined rotation number nx. The predetermined rotation number nx is a predetermined value (a constant) that is set in advance and is smaller than the starting rotation number na. For example, the predetermined rotation number nx can be determined to be equal to the above lower limit rotation number nt.

In the second control example, in the single pressurization of the upper braking unit SA, the target rotation number Nt of the electric motor MA is calculated from a pattern set by the predetermined time tx, the starting rotation number na, and the steady rotation number nb. When the pressurization transition occurs, the target rotation number Nt is determined to be the predetermined rotation number nx so as to be smaller than the target rotation number Nt (that is, the starting rotation number na) in the single pressurization of the upper braking unit SA. Therefore, the motor rotation number Na at the time of the pressurization transition is made smaller than the motor rotation number Na at the time of the single pressurization of the upper braking unit SA. By preventing the increase in the flow rate in the upper braking unit SA, a sudden increase in the servo pressure Pu is avoided, and therefore the fluctuations in the supply pressure Pm and the wheel pressure Pw are prevented.

In the above example, in the single pressurization of the upper braking unit SA, the switching from the starting rotation number na to the steady rotation number nb is performed as time elapses from the start of braking. Alternatively, a required speed dR, which is the amount of change over time in the required braking amount Bs, may be calculated, and the switching may be performed based on a magnitude relationship of the required speed dR.

Specifically, if the required speed dR is equal to or higher than a predetermined speed dr, the target rotation number Nt is determined to be the starting rotation number na, and if the required speed dR is less than the predetermined speed dr, the target rotation number Nt is determined to be the steady rotation number nb. Here, the “predetermined speed dr” is a predetermined value (a constant) set in advance. This is based on a matter that a flow rate of the braking liquid BF is required when the required speed dR is large.

Next, a case where the lower braking unit SB performs the pressurization when the upper braking unit SA performs the pressurization first will be described with reference to FIG. 6B. In this case, the target rotation number Nt is calculated as shown by a characteristic Xc (shown by a solid line). The upper braking unit SA performs the single pressurization until a time point t2, and thus the target rotation number Nt is determined to be the steady rotation number nb. Accordingly, the motor rotation number Na is maintained at a constant speed of the steady rotation number nb. When the upper braking unit SA starts pressurization at the time point t2, the target rotation number Nt is decreased to the predetermined rotation number nx. Similarly to the above, a change in the flow rate in the upper braking unit SA is avoided by decreasing the motor rotation number Na, and thus the fluctuation in the liquid pressure is prevented.

### OTHER EMBODIMENTS

Other embodiments will be described below. The same effects as those described above (such as prevention of the fluctuation in the liquid pressure at the time of pressurization performed by the lower braking unit SB) can be achieved in other embodiments as well.

In the above embodiment, in the rotation number control of the electric motor MA, the target rotation number Nt is calculated, and the actual rotation number Na is controlled based on this target rotation number Nt. There is a correlation between the motor rotation number Na and the supply current Im to the electric motor MA. Therefore, the rotation number Na of the electric motor MA may be controlled by adjusting the motor current Im without calculating the target rotation number Nt of the electric motor MA. In this configuration, when transitioning from the single pressurization to the joint pressurization, the motor current Im is decreased by a predetermined current im (a constant set in advance) and the motor rotation number Na is decreased.

In the above embodiment, a front-rear type is adopted for the braking system including two systems. Alternatively, a diagonal type (also referred to as “X type”) may be adopted for the braking system including two systems. In this configuration, one of the two master chambers Rm is connected to the left front wheel cylinder and the right rear wheel cylinder, and the other of the two master chambers Rm is connected to the right front wheel cylinder and the left rear wheel cylinder.

In the above embodiment, the tandem type master cylinder CM is exemplified. Alternatively, the single type master cylinder CM may be adopted. In this configuration, the secondary master piston NS is omitted. One master chamber Rm is connected to four wheel cylinders CW. In this configuration, the same supply pressures Pmf, Pmr (=Pm) are output from the master cylinder CM.

In a configuration in which the single-type master cylinder CM is adopted, the master chamber Rm may be connected to the front wheel cylinder CWf, and the pressure adjustment unit CA may be directly connected to the rear wheel cylinder CWr. In this configuration, the front wheel supply pressure Pmf is output from the master cylinder CM to the front wheel cylinder CWf as the front wheel pressure Pwf. On the other hand, the servo pressure Pu is output from the pressure adjustment unit CA to the rear wheel cylinder CWr as the rear wheel supply pressure Pmr.

In the embodiment described above, the pressure receiving area rm (the master area) of the master chamber Rm and the pressure receiving area ru (the servo area) of the servo chamber Ru are set equal to each other in the applying unit AP. The master area rm and the servo area ru do not have to be equal. In a configuration in which the master area rm and the servo area ru are different, a conversion calculation between the supply pressure Pm and the servo pressure Pu can be performed based on a ratio of the servo area ru to the master area rm (that is, the conversion based on “Pm·rm=Pu·ru”).

### SUMMARY OF EMBODIMENTS

The embodiments of the braking control device SC will be summarized. The braking control device SC is provided with the two braking units SA, SB as the pressurization sources of the wheel pressure Pw. In the upper braking unit SA, the supply pressure Pm is pressurized by throttling, with the pressure adjustment valve UA, the circulation flow KN discharged by the fluid pump QA driven by the electric motor MA. The supply pressure Pm is finally output to the wheel cylinder CW, and thus the wheel pressure Pw is pressurized by the supply pressure Pm. The lower braking unit SB is disposed between the upper braking unit SA and the wheel cylinder CW. The supply pressure Pm is pressurized by the lower braking unit SB and output to the wheel cylinder CW as the wheel pressure Pw. In the braking control device SC, when the lower braking unit SB does not perform the pressurization, the supply pressure Pm pressurized by the upper braking unit SA is supplied to the wheel cylinder CW as the wheel pressure Pw. Conversely, when the upper braking unit SA does not perform the pressurization, the supply pressure Pm is “0 (the atmospheric pressure)”, and thus the wheel pressure Pw is pressurized from “0” by the lower braking unit SB.

In the upper braking unit SA, when the lower braking unit SB pressurizes the wheel pressure Pw (that is, when a liquid pressure difference occurs between the supply pressure Pm and the adjustment pressure Pq), the electric motor MA is controlled to have a smaller rotation number Na than that when the lower braking unit SB does not pressurize the wheel pressure Pw (when no liquid pressure difference occurs between the supply pressure Pm and the adjustment pressure Pq). That is, the motor rotation number Na when the lower braking unit SB pressurizes the wheel pressure Pw is smaller than the motor rotation number Na when the lower braking unit SB does not pressurize the wheel pressure Pw.

In order to increase the wheel pressure Pw, it is necessary for the braking liquid BF to flow into the wheel cylinder CW. An amount of braking liquid BF (amount of liquid consumed) at this time depends on the rigidity of the braking device SX (CP, MS, and the like). In order to increase the wheel pressure Pw from “0”, a large amount of braking liquid BF is required. However, when the wheel pressure Pw is increased to a certain extent, the amount of braking liquid BF is not so much required. Furthermore, when the lower braking unit SB performs the pressurization, the wheel pressure Pw is increased from the supply pressure Pm. That is, since the wheel pressure Pw is higher than the supply pressure Pm, the braking liquid BF is not moved from the upper braking unit SA to the wheel cylinder CW. If the upper braking unit SA supplies the same amount of braking liquid BF in the pressurization state of the lower braking unit SB as in the non-pressurization state of the lower braking unit SB, an excess flow rate occurs in the upper braking unit SA. Therefore, an increase in the supply pressure Pm (=Pu) occurs during the pressurization transition. The supply pressure Pm converges to the target pressure Pt by the feedback control, but becomes oscillatory in the process. In the braking control device SC, when the lower braking unit SB has already pressurized the wheel pressure Pw, the rotation number Na of the electric motor MA is decreased so that the flow rate in the upper braking unit SA is smaller than that when the lower braking unit SB does not pressurize the wheel pressure Pw. Since the flow rate change in the upper braking unit SA is prevented, the fluctuation in the liquid pressure is decreased.

In the braking control device SC, the electric motor MA can be controlled based on the flow rate control. In this control, the rotation number Na of the electric motor MA is controlled based on the instruction flow rate Qs calculated from the target pressure Pt and the compensation flow rate Qh calculated from the supply pressure Pm. Here, the instruction flow rate Qs is a flow rate required to achieve the target pressure Pt, and corresponds to the feedforward term in the flow rate control. The compensation flow rate Qh is a flow rate required for the supply pressure Pm to coincide with the target pressure Pt, and corresponds to the feedback term in the flow rate control. The electric motor MA is controlled by the flow rate control to ensure a minimum required flow rate, thereby the power consumption of the electric motor MA is suppressed. The target pressure Pt is calculated based on the required braking amount Bs so as to be greater as the required braking amount Bs increases.

In the upper braking unit SA, when the lower braking unit SB does not pressurize the wheel pressure Pw, the rotation number Na of the electric motor MA is controlled based on the instruction flow rate Qs and the compensation flow rate Qh. Specifically, the motor rotation number Na is controlled based on the target flow rate Qt, which is the sum of the instruction flow rate Qs and the compensation flow rate Qh. On the other hand, when the lower braking unit SB pressurizes the wheel pressure Pw, the rotation number Na of the electric motor MA is controlled based only on the compensation flow rate Qh. Specifically, the motor rotation number Na is controlled based on the target flow rate Qt, “Qs=0” is determined, and “Qt=Qh” is calculated. According to this configuration, the motor rotation number Na when the lower braking unit SB pressurizes the wheel pressure Pw is made smaller by the instruction flow rate Qs than the motor rotation number Na when the lower braking unit SB does not pressurize the wheel pressure Pw. Accordingly, similar to above, the flow rate change in the upper braking unit SA is prevented, and fluctuation in the liquid pressure is decreased.

1. A braking control device for a vehicle, comprising:
an upper braking unit configured to pressurize a supply pressure by throttling, with a pressure adjustment valve, a circulation flow discharged by a fluid pump driven by an electric motor; and
a lower braking unit disposed between the upper braking unit and a wheel cylinder and configured to pressurize the supply pressure to output a wheel pressure to the wheel cylinder, wherein
in a case where the lower braking unit pressurizes the wheel pressure, the upper braking unit reduces a rotation number of the electric motor as compared with a case where the lower braking unit does not pressurize the wheel pressure.

2. A braking control device for a vehicle, comprising:
an upper braking unit configured to, according to a required braking amount, pressurize a supply pressure by throttling, with a pressure adjustment valve, a circulation flow discharged by a fluid pump driven by an electric motor; and
a lower braking unit disposed between the upper braking unit and a wheel cylinder and configured to pressurize the supply pressure to output a wheel pressure to the wheel cylinder, wherein
the upper braking unit is configured to
calculate a target pressure based on the required braking amount,
when the lower braking unit does not pressurize the wheel pressure, control a rotation number of the electric motor based on an instruction flow rate calculated from the target pressure and a compensation flow rate calculated from the supply pressure, and
when the lower braking unit pressurizes the wheel pressure, control the rotation number of the electric motor based only on the compensation flow rate.
